(19) United States
(12) Patent Application Publication
(10) Pub. No.: US 2025/0158066 A1
(43) Pub. Date: May 15, 2025

(54) NEGATIVE ELECTRODE AND METHOD OF PRODUCING THE SAME

(71) Applicant: TOYOTA JIDOSHA KABUSHIKI KAISHA, Toyota-shi (JP)

(72) Inventor: Masaharu Senoue, Seto-shi (JP)

(73) Assignee: TOYOTA JIDOSHA KABUSHIKI KAISHA, Toyota-shi (JP)

(21) Appl. No.: 18/785,455

(22) Filed: Jul. 26, 2024

(30) Foreign Application Priority Data
Nov. 13, 2023 (JP) 2023-192739

(51) Int. Cl. H01M 4/62; H01M 4/02; H01M 4/38; H01M 4/66

(52) U.S. Cl. CPC H01M 4/622; H01M 4/386; H01M 4/663; H01M 2004/021; H01M 2004/027

(57) ABSTRACT

A method of producing a negative electrode includes a process of preparing granule particles containing a Si-based active material, a conductive material, and a first binder having an imide framework, a process of preparing a negative electrode mixture containing the granule particles, graphite particles, and a second binder having no imide framework, and a process of applying the negative electrode mixture to a current collector and performing drying, wherein the weight percentage of the first binder contained in the granule particles is 5% or more and 15% or less, and the granule particles have an average diameter of 50 μm or less.

### CROSS-REFERENCE TO RELATED APPLICATION

This application claims priority to Japanese Patent Application No. 2023-192739 filed on Nov. 13, 2023, incorporated herein by reference in its entirety.

### BACKGROUND

### 1. Technical Field

The present disclosure relates to a negative electrode and a method of producing the same.

### 2. Description of Related Art

Regarding the negative electrode as disclosed in Japanese Unexamined Patent Application Publication No. 2016-225079 (JP 2016-225079 A), various techniques have been proposed.

### SUMMARY

In active materials that expand and contract, such as Si, it is required to use high-strength binders such as polyimide binders, but polyimide binders have low conductivity and tend to increase resistance, and thus they are not able to be added in large amounts to electrodes using Si-based active materials, and in the related art, capacity deterioration due to expansion and contraction of Si-based active materials could not be sufficiently reduced.

The present disclosure has been made in view of the above circumstances, and a main object of the present disclosure is to provide a negative electrode that can improve an initial discharging capacity and a capacity retention rate of a lithium ion secondary battery, and a method of producing the same.

Specifically, the present disclosure includes the following aspects.

<1> A method of producing a negative electrode, including
a process of preparing granule particles containing a Si-based active material, a conductive material, and a first binder having an imide framework;
a process of preparing a negative electrode mixture containing the granule particles, graphite particles, and a second binder having no imide framework; and
a process of applying the negative electrode mixture to a current collector and performing drying,
wherein the weight percentage of the first binder contained in the granule particles is 5% or more and 15% or less, and
wherein the granule particles have an average diameter of 50 μm or less.

<2> The method according to <1>,
wherein the first binder is at least one of polyimides and polyamide-imides.

<3> The method according to <1> or <2>,
wherein the second binder is at least one selected from the group consisting of carboxymethylcellulose, styrene-butadiene rubber, and polyacrylic acid.

<4> The method according to any one of <1> to <3>,
wherein the Si-based active material is at least one selected from the group consisting of elemental Si, a Si oxide, and a Si alloy.

<5> A negative electrode including a current collector and a negative electrode mixture arranged on the current collector,
wherein the negative electrode mixture contains granule particles containing a Si-based active material, a conductive material, and a first binder having an imide framework, graphite particles, and a second binder having no imide framework,
wherein the weight percentage of the first binder contained in the granule particles is 5% or more and 15% or less, and
wherein the granule particles have an average diameter of 50 μm or less.

According to the negative electrode and the method of producing the same of the present disclosure, it is possible to improve an initial discharging capacity and a capacity retention rate of a lithium ion secondary battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view showing an example of granule particles of the present disclosure; and

FIG. 2 is a schematic cross-sectional view showing an example of a negative electrode of the present disclosure.

### DETAILED DESCRIPTION OF EMBODIMENTS

Embodiments of the present disclosure will be described below. Here, components other than those particularly mentioned in this specification that are necessary for implementation of the present disclosure (for example, a general configuration and a production process of a negative electrode that do not characterize the present disclosure) can be recognized by those skilled in the art as design matters based on the related art in the field. The present disclosure can be implemented based on content disclosed in this specification and common general technical knowledge in the field.

In the present disclosure, unless otherwise specified, the average particle size of particles is a volume-based median diameter (D50) value measured by laser diffraction/scattering particle size distribution measurement. In addition, in the present disclosure, the median diameter (D50) is a diameter (volume average diameter) at which the cumulative volume of particles is half (50%) of the total volume when particles are arranged in descending order of their particle size.

In the present disclosure, a method of producing a negative electrode includes
a process of preparing granule particles containing a Si-based active material, a conductive material, and a first binder having an imide framework,
a process of preparing a negative electrode mixture containing the granule particles, graphite particles, and a second binder having no imide framework, and
a process of applying the negative electrode mixture to a current collector and performing drying,
the weight percentage of the first binder contained in the granule particles is 5% or more and 15% or less, and
the granule particles have an average diameter of 50 μm or less.

In order to reduce capacity deterioration due to expansion and contraction of Si-based active materials, it is essential to use a combination of a high-strength binder that minimizes the distance between particles and a conductive material that assists with maintaining electron paths between particles.

Although it depends on the usage and type of Si-based active materials, generally, in the case of electrodes of a Si-based active material alone (not composited with graphite particles), as a weight ratio of Si-based active material:high-strength binder:conductive material in the mixture, a ratio of about 80:15:5 is often used in research fields.

Typical high-strength binders that can be used in the negative electrode of a lithium ion secondary battery include polyimides and polyacrylic acid, each of which has the following features.

It can be said that polyimides have high elasticity and high ductility and are most suitable as a Si-based active material. In addition, polyimides allow ion permeability because a part of its framework reacts with Li, and even if the polyimides are mixed into a mixture at a relatively high percentage (5% or more), the electrode resistance does not significantly increase. The disadvantages of polyimides are that the materials are expensive, they do not easily dissolve in water, a paste tends to become an NMP type, and in a binder solution state, polyimides are in a state of polyamic acid and it is necessary to perform a heat treatment at about 250° C. or higher in order to perform conversion into polyimides, and the irreversible capacity of the negative electrode increases because polyimides react with Li.

Although polyacrylic acid is inferior to polyimides in terms of ductility, it has high elasticity comparable to polyimides. In addition, polymers can be easily dissolved in an aqueous solution, and a heat treatment for curing is not necessary. However, since polyacrylic acid causes poor ion permeability and tends to increase electrode resistance, the amount thereof added into the mixture is within 3% in many cases (characteristics vary somewhat depending on the molecular weight and the like).

Based on this premise, in the present disclosure, a structure in which, when the high-strength binder is used in a mixed electrode in which a Si-based active material and graphite particles are combined, the binder is provided only around the necessary Si-based active material is used.

In the present disclosure, a structure in which granules in which a Si-based active material and a conductive material are firmly fixed with polyimides, which can be used in a relatively large amount, are prepared first, and the granules are fixed with graphite particles and a small amount of polyacrylic acid is used.

The advantages of this method are that, since a granule producing process in which polyimides are used and an electrode coating process are separated, there is no need to fire the electrode itself, which is advantageous for mass production, since the polyimides and the conductive material are provided only around the Si-based active material, the amount thereof used can be kept to a minimum in consideration of the entire electrode, and since granules in which particles are firmly fixed to each other are additionally combined with graphite and a current collector using another binder, it is easy to achieve high strength with a small amount of the binder in total.

In the present disclosure, when a specific amount of the polyimides and the conductive material necessary for improving durability is provided around the active material, it is possible to improve charging/discharging efficiency.

The irreversible capacity can be minimized by providing the polyimides and the conductive material necessary for improving Si durability only around the Si-based active material. In addition, although the polyacrylic acid is a relatively strong binder, an ion permeability therewith is lower than that with the polyimides, and it is not possible to increase the amount thereof added. The polyimides in the granules compensate for the lack of the binder, and thus the charging/discharging efficiency can be improved. In addition, it is generally necessary to heat polyimides at 250° C. or higher for imidization of polyamic acid, but in the present disclosure, the granules alone can be heated, and thus there is no need to take measures against oxidation of the current collector and decomposition of polyacrylic acid due to heating.

The method of producing a negative electrode of the present disclosure includes a process of preparing granule particles, a process of preparing a negative electrode mixture, and a drying process.

### Process of Preparing Granule Particles

The process of preparing granule particles is a process of preparing granule particles containing a Si-based active material, a conductive material, and a first binder having an imide framework.

In order to prepare granule particles, a granule particle paste containing a Si-based active material, a conductive material, a first binder having an imide framework, and a solvent such as N-methylpyrrolidone (NMP) is produced, and a spray-type granulation treatment may be performed using the granule particle paste.

The weight percentage of the first binder contained in the granule particles is 5% or more and 15% or less.

The average diameter of the granule particles may be 50 μm or less, 47 μm or less, or 14 μm or more.

The average diameter of the granule particles is observed under an SEM, and the longest straight line connecting two points on the outer circumference is determined as the diameter of the granule particles, and the average diameter is calculated by observing 20 granule particles.

The first binder may be at least one of polyimides and polyamide-imides.

The Si-based active material may be at least one selected from the group consisting of elemental Si, a Si oxide, a Si—C composite, and a Si alloy.

As the conductive material, known materials can be used, and examples thereof include carbon materials and metal particles. Examples of carbon materials include acetylene black (AB), furnace black, VGCF, carbon nanotubes (CNT), and carbon nanofibers. Among these, in consideration of electron conductivity, at least one selected from the group consisting of VGCF, carbon nanotubes, and carbon nanofibers may be used. Examples of metal particles include Ni, Cu, Fe, and SUS particles.

The content of the conductive material in the granule particles is not particularly limited, and the weight percentage of the conductive material contained in the granule particles may be 1% or more and 5% or less.

### Process of Preparing Negative Electrode Mixture

The process of preparing a negative electrode mixture is a process of preparing a negative electrode mixture containing the granule particles, graphite particles, and a second binder having no imide framework.

The graphite particles may be at least one selected from the group consisting of natural graphite particles and artificial graphite particles.

The second binder may be at least one selected from the group consisting of carboxymethylcellulose (CMC), styrene-butadiene rubber (SBR), and polyacrylic acid.

The weight percentage of the granule particles contained in the negative electrode mixture may be 6% or more and 21.6% or less.

The weight percentage of the graphite particles contained in the negative electrode mixture may be 76.7% or more and 92.2% or less.

The weight percentage of the second binder contained in the negative electrode mixture may be 0.2% or more and 1.6% or less.

The negative electrode mixture contains, as necessary, the conductive material.

### Drying Process

The drying process is a process of applying the negative electrode mixture to a current collector and performing drying.

The material of the current collector may be a material that is not alloyed with Li, and examples thereof include SUS, copper, and nickel. Examples of the form of the current collector include a foil form and a plate form. The shape of the current collector in a plan view is not particularly limited, and examples thereof include a circular shape, an elliptical shape, a rectangular shape and any polygonal shape. In addition, the thickness of the current collector varies depending on the shape, and may be, for example, in a range of 1 μm to 50 μm or in a range of 5 μm to 20 μm.

As a method of applying and drying a negative electrode mixture on a current collector, for example, a negative electrode mixture is added to a solvent and stirred to produce a negative electrode layer slurry, the negative electrode layer slurry is applied and dried on one surface of a support such as a current collector, and thereby a negative electrode layer is obtained.

Examples of solvents include butyl acetate, butyl butyrate, heptane, and N-methyl-2-pyrrolidone.

The method of applying a negative electrode layer slurry onto one surface of a support such as a current collector is not particularly limited, and examples thereof include a doctor blade method, a metal mask printing method, an electrostatic coating method, a dip coating method, a spray coating method, a roll coating method, a gravure coating method, and a screen printing method.

As the support, one having self-supporting properties can be appropriately selected and used, and the support is not particularly limited, and for example, a metal foil such as Cu and Al can be used.

The negative electrode of the present disclosure is a negative electrode including a current collector and a negative electrode mixture arranged on the current collector,
the negative electrode mixture contains granule particles containing a Si-based active material, a conductive material, and a first binder having an imide framework, graphite particles, and a second binder having no imide framework,
the weight percentage of the first binder contained in the granule particles is 5% or more and 15% or less, and
the granule particles have an average diameter of 50 μm or less.

The negative electrode includes a current collector and a negative electrode mixture arranged on the current collector.

The current collector and the negative electrode mixture are as described above.

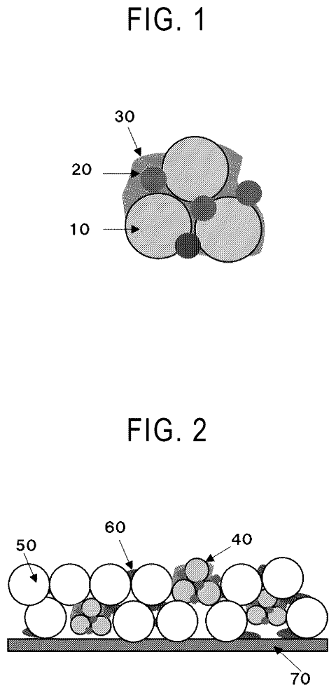

FIG. 1 is a schematic cross-sectional view showing an example of granule particles of the present disclosure.

As shown in FIG. 1, the granule particles include a Si-based active material 10, a conductive material 20, and a first binder 30 having an imide framework.

FIG. 2 is a schematic cross-sectional view showing an example of the negative electrode of the present disclosure.

As shown in FIG. 2, the negative electrode includes a negative electrode current collector 70 and a negative electrode mixture arranged on the negative electrode current collector 70, and the negative electrode mixture contains granule particles 40, graphite particles 50, and a second binder 60 having no imide framework.

The negative electrode of the present disclosure is used in a lithium ion secondary battery.

The lithium ion secondary battery includes a positive electrode, the negative electrode of the present disclosure, and an electrolyte layer between the positive electrode and the negative electrode.

As necessary, the lithium ion secondary battery includes an exterior body in which a positive electrode, a negative electrode, an electrolyte layer and the like are accommodated.

The material of the exterior body is not particularly limited as long as it is stable in an electrolyte, and examples thereof include resins such as polypropylene, polyethylene, and acrylic resins.

Examples of shapes of lithium ion secondary batteries include a coin shape, a laminate shape, a cylindrical shape and a rectangular shape.

The lithium ion secondary battery may be a liquid lithium ion secondary battery using an electrolytic solution as an electrolyte or a solid lithium ion secondary battery using a solid electrolyte as an electrolyte. Applications of lithium ion secondary batteries include power sources for vehicles, for example, hybrid vehicles (HEV), plug-in hybrid vehicles (PHEV), battery electric vehicles (BEV), gasoline vehicles, and diesel vehicles. Among these, the battery may be used as a power source for driving hybrid vehicles (HEV), plug-in hybrid vehicles (PHEV) or battery electric vehicles (BEV). In addition, the lithium ion secondary battery may be used as a power source for moving objects (for example, trains, ships, and aircrafts) other than vehicles, and may be used as a power source for electrical products such as information processing devices.

### Example 1

### Production of Positive Electrode

A positive electrode active material (average particle size: 10 μm, LiNi_{0.8}Co_{0.1}Mn_{0.1}O₂), a conductive material (granular acetylene black), and a binding agent (PVdF) were kneaded with NMP at a ratio of 93:4:3 to produce a positive electrode paste. The solid content of the paste was adjusted using NMP to be 65%. The produced positive electrode paste was applied onto an aluminum foil with a thickness of 15 μm using a blade coater and dried in a drying furnace at 120° C. for 10 minutes to obtain a coated body. The weight per unit area of one surface after drying was adjusted to 22 mg/cm². Next, the coated body was pressed using a roll press machine. The positive electrode mixture density of the pressed positive electrode was 2.9 g/cc.

### Production of Negative Electrode Granule Particles

Silicon monoxide particles with an average particle size of 6 μm were used as a negative electrode active material, polyamic acid (U Varnish A, commercially available from UBE Corporation) was used as a binding agent (first binder), and ketjen black was used as a conductive material. These were mixed in a ratio of 85:10:5, and NMP was added and kneaded to produce a paste with a solid content of 52%. Next, using this paste, a spray-type granulation treatment was performed using Mini Spray Dryer B290 (commercially available from Buchi). The drying temperature after spraying was 200° C. The obtained granule particles were put into an atmosphere furnace and fired under an argon atmosphere at 400° C. for 30 minutes. The average diameter of the granule particles after the treatment was observed under an SEM. Since the granule particles had an irregular shape, the longest straight line connecting two points on the outer circumference was determined as the diameter of the granule particles, and the average diameter was calculated by observing 20 granule particles. In this result, the average diameter of the granule particles was 28 μm.

### Production of Negative Electrode

16 g of spherical natural graphite with an average particle size of 17 μm, 4.5 g of the granule particles, 3 g of a polyacrylic acid solution (SW-100, commercially available from Sumitomo Seika Chemicals Co., Ltd.) as a binding agent (second binder), and 15 g of deionized water were mixed and kneaded for 20 minutes using a planetary mixer to prepare a coating paste. Next, the paste was applied to a copper foil with a thickness of 15 μm using a blade coater and dried at 120° C. for 10 minutes. This negative electrode was pressed using a roll press machine. Here, the coating gap of the blade coater was adjusted to obtain a desired weight per unit area. The weight per unit area of the obtained negative electrode was 6.3 mg/cm².

### Production of Coin-Type Battery

The positive electrode and negative electrode were punched out into a disk shape with a diameter of 16 mm, and were set to face each other with a disk-shaped separator with a diameter of 19 mm (a polyethylene porous component with a porosity of 55% and a thickness of 20 μm) therebetween, and installed in a coin-type battery can. 100 μl of an electrolytic solution (EC:FEC:EMC:DMC=0.2:0.1:0.3:0.4 (Vol ratio), LIPF₆1 [mol/kg]) was added to the electrode body, the coin can was sealed by caulking to produce a coin-type battery.

### Evaluation of Battery Characteristics

A charging/discharging test was performed in the manner described below.

### Initial Charging/Discharging

Charging: 4.2 V, CCCV, 0.1 mA cut, current value: 1 mA
Discharging: 2.5 V, CCCV, 0.1 mA cut, current value: 1 mA

### Calculation of Capacity

The initial discharging capacity [mAh] was used.

### Measurement of DC Resistance

It was calculated from the voltage drop when the initial discharging started.

### Cycle Test (100 Cycles)

Charging: 4.2 V, CCCV, 0.5 mA cut, current value: 5 mA
Discharging: CC2.5 V cut, current value: 0.5 mA

Table 1 shows the compositions of granule particles, Table 2 shows the configurations of negative electrode mixtures, and Table 3 shows the charging/discharging test results.

### Example 2 and Comparative Example 6

The same method as in Example 1 was performed except that the percentage of polyimides in the granule particles was changed as shown in Table 1.

### Example 3, Example 4, and Comparative Example 7

The same method as in Example 1 was performed except that the average diameter of the granule particles was changed as shown in Table 1 by adjusting the solid content of the spray paste during granulation.

### Example 5

The same method as in Example 1 was performed except that the silicon-based active material used in the granule particles was changed to silicon particles with an average particle size of 0.7 μm.

### Example 6

The silicon particles used in Example 5, a polyamic acid (U VARNISH A, commercially available from UBE Corporation) solution, and polyvinylidene fluoride (#7300) were mixed at a weight ratio of 1:15:3, and then fired in an atmosphere furnace under an Ar atmosphere at 1,200° C. for 1 hour. The fired solid was crushed with a ball mill and divided into spheres with a sieve to obtain a Si—C composite with an average particle size of 3 μm. The same method as in Example 1 was performed except that this Si—C composite was used as the active material of the granule particles.

### Example 7

The same method as in Example 1 was performed except that the first binder used in the granule particles was changed to polyamide-imide using a polyamide-imide solution (Vylomax HR-11MM, commercially available from Toyobo Co., Ltd.).

### Example 8

The same method as in Example 1 was performed except that the conductive material used in the granule particles was changed to CNTs (TUBALL, commercially available from OCSIAL), and the same CNTs were added to the negative electrode mixture with the composition shown in Table 2.

### Example 9

The same method as in Example 1 was performed except that the second binder used in the negative electrode mixture was changed to CMC and SBR with the composition shown in Table 2.

### Example 10

The same method as in Example 1 was performed except that the graphite particles used in the negative electrode mixture were changed to artificial graphite with an average particle size of 10 μm.

### Comparative Examples 1 to 5

The same method as in Example 1 was performed except that SiO used in the granule particles of Example 1 was directly mixed into the negative electrode mixture without using granule particles and the compositions shown in Table 2 were used.

TABLE 1

| | | | Conduc- | | |
|---|---|---|---|---|---|
| | Active | First | tive | Weight | Average |
| | material | binder | material | ratio | diameter |
| Test | (1) | (2) | (3) | (1:2:3) | [μm] |
| Example 1 | SiO | Polyimide | KB | 85:15:5 | 28 |
| Example 2 | SiO | Polyimide | KB | 85:5:5 | 32 |
| Example 3 | SiO | Polyimide | KB | 85:15:5 | 47 |
| Example 4 | SiO | Polyimide | KB | 85:15:5 | 14 |
| Example 5 | Si | Polyimide | KB | 85:15:5 | 31 |
| Example 6 | Si—C | Polyimide | KB | 85:15:5 | 41 |
| | composite | | | | |
| Example 7 | SiO | Polyamide- | KB | 85:15:5 | 29 |
| | | imide | | | |
| Example 8 | SiO | Polyimide | CNT | 85:15:1 | 31 |
| Example 9 | SiO | Polyimide | KB | 85:15:1 | 31 |
| Example 10 | SiO | Polyimide | KB | 85:15:1 | 31 |
| Comparative | SiO | Polyimide | KB | 85:2:5 | 35 |
| Example 6 | | | | | |
| Comparative | SiO | Polyimide | KB | 85:15:5 | 72 |
| Example 7 | | | | | |

TABLE 2

| | Granules | | | | | Weight |
|---|---|---|---|---|---|---|
| | or active | Active | Second | Conductive | Weight | per unit |
| | material | material | binder | material | ratio | area |
| Test | A (1) | B (2) | (3) | (4) | (1:2:3:4) | [mg/cm²] |
| Example 1 | Granules | Natural | Polyacrylic | None | 21.6:76.8:1.6 | 7.4 |
| | described | graphite | acid | | | |
| | in Table 1 | | | | | |
| Example 2 | Granules | Natural | Polyacrylic | None | 21.6:76.8:1.6 | 7.4 |
| | described | graphite | acid | | | |
| | in Table 1 | | | | | |
| Example 3 | Granules | Natural | Polyacrylic | None | 21.6:76.8:1.6 | 7.4 |
| | described | graphite | acid | | | |
| | in Table 1 | | | | | |
| Example 4 | Granules | Natural | Polyacrylic | None | 21.6:76.8:1.6 | 7.4 |
| | described | graphite | acid | | | |
| | in Table 1 | | | | | |
| Example 5 | Granules | Natural | Polyacrylic | None | 6:92.2:1.6 | 8.4 |
| | described | graphite | acid | | | |
| | in Table 1 | | | | | |
| Example 6 | Granules | Natural | Polyacrylic | None | 21.6:76.8:1.6 | 6.3 |
| | described | graphite | acid | | | |
| | in Table 1 | | | | | |
| Example 7 | Granules | Natural | Polyacrylic | None | 21.6:76.8:1.6 | 7.4 |
| | described | graphite | acid | | | |
| | in Table 1 | | | | | |
| Example 8 | Granules | Natural | Polyacrylic | CNT | 21.5:76.7:1.6:0.2 | 7.4 |
| | described | graphite | acid | | | |
| | in Table 1 | | | | | |
| Example 9 | Granules | Natural | CMC and | None | 21.6:76.8:1.6 | 7.4 |
| | described | graphite | SBR | | | |
| | in Table 1 | | (weight | | | |
| | | | ratio 1:1) | | | |
| Example 10 | Granules | Artificial | Polyacrylic | None | 21.6:76.8:1.6 | 7.6 |
| | described | graphite | acid | | | |
| | in Table 1 | | | | | |
| Comparative | SiO | Natural | Polyimide | KB | 17.4:76:1.6:5 | 8.6 |
| Example 1 | | graphite | | | | |
| Comparative | SiO | Natural | Polyimide | KB | 14.7:65.3:15:5 | 7.0 |
| Example 2 | | graphite | | | | |
| Comparative | SiO | Natural | Polyacrylic | KB | 17.4:76:1.6:5 | 8.6 |
| Example 3 | | graphite | acid | | | |
| Comparative | SiO | Natural | Polyacrylic | KB | 14.7:65.3:15:5 | 10.1 |
| Example 4 | | graphite | acid | | | |
| Comparative | SiO | Natural | CMC and | KB | 17.4:76:1.6:5 | 8.6 |
| Example 5 | | graphite | SBR | | | |
| | | | (weight | | | |
| | | | ratio 1:1) | | | |
| Comparative | Granules | Natural | Polyacrylic | None | 21.6:76.8:1.6 | 7.4 |
| Example 6 | described | graphite | acid | | | |
| | in Table 1 | | | | | |
| Comparative | Granules | Natural | Polyacrylic | None | 21.6:76.8:1.6 | 7.8 |
| Example 7 | described | graphite | acid | | | |
| | in Table 1 | | | | | |

TABLE 3

| | Initial discharging | Capacity retention |
|---|---|---|
| Test | capacity [mAh] | rate [%] |
| Example 1 | 8.00 | 93 |
| Example 2 | 8.02 | 88 |
| Example 3 | 8.10 | 93 |
| Example 4 | 8.05 | 93 |
| Example 5 | 8.41 | 89 |
| Example 6 | 8.30 | 91 |
| Example 7 | 8.05 | 92 |
| Example 8 | 8.01 | 95 |
| Example 9 | 8.00 | 90 |
| Example 10 | 8.07 | 93 |
| Comparative Example 1 | 7.90 | 45 |
| Comparative Example 2 | 6.44 | 88 |
| Comparative Example 3 | 8.42 | 37 |
| Comparative Example 4 | 3.14 | 2 |
| Comparative Example 5 | 7.66 | 22 |
| Comparative Example 6 | 8.01 | 34 |
| Comparative Example 7 | 7.95 | Short-circuiting stop at |
| | | 25th cycle |

Consideration about Results

Comparing Example 1, Example 2, and Comparative Example 6, it was found that, when the percentage of the first binder in the granules was too low, the cycle characteristics deteriorated.

Comparing Example 1, Example 3, Example 4, and Comparative Example 7, it was found that, when the size of the granules was larger than 50 μm, short-circuiting behavior occurred during cycles.

In Comparative Example 7, when the electrode after short circuiting was observed, unevenness due to lithium precipitation was observed, and thus it was thought that, when the granules were too large, the in-plane unevenness of the lithium acceptance capacity in the negative electrode mixture became too large, and a non-uniform charging/discharging reaction occurred.

In Example 6 to Example 10, some of the materials were changed, and even in this case, the effects of the present disclosure were confirmed.

Comparing Example 1 with Comparative Example 1, and Comparative Example 2, it was found that, when simply mixed as in Comparative Example 1 and Comparative Example 2 without using granules, in Comparative Example 1 in which a very small amount of polyimides was used, the cycle characteristics deteriorated, and when the polyimide percentage was increased to almost the same as the polyimide percentage in the granules of Example 1 as in Comparative Example 2, the amount of polyimides in the entire negative electrode mixture became too large, and the initial capacity deceased due to the generation of the irreversible capacity. Here, when the capacity decreased to that of Comparative Example 2, the energy density of the battery was lower than when an electrode with graphite alone without SiO mixed into it was used.

It was found that, regarding Comparative Example 3 and Comparative Example 4, as in Comparative Example 1, no granules were used and polyacrylic acid was used as the binder in the negative electrode mixture, but when the amount of the binder was small as in Comparative Example 3, the cycle characteristics deteriorated, and when the amount of the binder was large, the battery resistance became very high, and both the initial capacity and the cycle characteristics significantly deteriorated.

In Comparative Example 5, as in Comparative Example 1, no granules were used, and the binder was changed to CMC and SBR, which are commonly used in graphite negative electrodes, but the cycle characteristics significantly deteriorated as in Comparative Example 1 and Comparative Example 3.

Comparing Example 1 with Comparative Examples 1 to 5, it was found that both the initial discharging capacity and the capacity retention rate could be improved by using the granules.

What is claimed is:

1. A method of producing a negative electrode, comprising:
a process of preparing granule particles containing a Si-based active material, a conductive material, and a first binder having an imide framework;
a process of preparing a negative electrode mixture containing the granule particles, graphite particles, and a second binder having no imide framework; and
a process of applying the negative electrode mixture to a current collector and performing drying,
wherein the weight percentage of the first binder contained in the granule particles is 5% or more and 15% or less, and
wherein the granule particles have an average diameter of 50 μm or less.

2. The method according to claim 1,
wherein the first binder is at least one of polyimides and polyamide-imides.

3. The method according to claim 1,
wherein the second binder is at least one selected from the group consisting of carboxymethylcellulose, styrene-butadiene rubber, and polyacrylic acid.

4. The method according to claim 1,
wherein the Si-based active material is at least one selected from the group consisting of elemental Si, a Si oxide, and a Si alloy.

5. A negative electrode comprising a current collector and a negative electrode mixture arranged on the current collector,
wherein the negative electrode mixture contains granule particles containing a Si-based active material, a conductive material, and a first binder having an imide framework, graphite particles, and a second binder having no imide framework,
wherein the weight percentage of the first binder contained in the granule particles is 5% or more and 15% or less, and
wherein the granule particles have an average diameter of 50 μm or less.
